(19) United States
(12) Patent Application Publication
(10) Pub. No.: US 2011/0215048 A1
(43) Pub. Date: Sep. 8, 2011

(54) TO WATER TREATMENT SYSTEMS

(75) Inventors: Douglas Steward Moreland Phillips, Waihi (NZ); Peter Alfred John Phillips, Hamilton (NZ)

(73) Assignee: PETA ENTERPRISES LIMITED, Hamilton (NZ)

(21) Appl. No.: 13/000,192

(22) PCT Filed: Jun. 18, 2009
(86) PCT No.: PCT/NZ2009/000116

§ 371 Date: May 26, 2011

(30) Foreign Application Priority Data
Jun. 18, 2008 (NZ) 569190

(51) Int. Cl. C02F 1/50

(52) U.S. Cl. 210/501

(57) ABSTRACT

The present invention is directed to a fluid flow control assembly for regulating fluid flow, and may find particular application in additive dispenser systems. Typically a baffle arrangement (210) comprises a plurality of baffle elements (202) within a chamber (208). The arrangement forms an alternating sequence of restrictions and cavities for fluid flowing from an inlet (205) to an outlet (201) and tends to restrict fluid flow in an alternative manner to merely providing a fine diameter aperture. The fluid flow control assembly was developed for applications where foreign particles or air bubbles may block fine diameter apertures, such as low pressure additive dispenser systems where low relatively stable flow rates are important to their operation.

### FIELD OF INVENTION

The present invention is generally directed to fluid flow control assemblies for low fluid flows, and their use in dispenser arrangements for the incorporation of additives to a fluid supply.

### BACKGROUND DESCRIPTION

The applicant has previously invented an additive for dispensing solid additives to animal troughs and water supplies. This is the subject of NZ Patent 202233. This dispensing system comprised an additive reservoir and a dosing chamber separated by a plurality of apertures. Water from the dosing chamber would slowly diffuse into the additive reservoir to mix with solid additive therein. A solution of additive would generally diffuse back into the dosing chamber. An inlet and outlet were provided in the dosing chamber to allow water (from a supply) to enter the dosing chamber, and to exit into a trough or water supply. The rate by which additive was introduced to the trough or supply was proportional largely on the rate of diffusion of solution into the dosing chamber, and diffusion subsequently therefrom. Rather than being an in-line system in which water pressure was used to pump fresh water into (and force dosed water from) the dosing chamber, the principle of the invention relied upon the weight of the heavier solution (with additive) exiting the dosing chamber through the outlet, and thus drawing new water into the chamber. The diffusion between the additive reservoir and dosing chamber also relied upon a similar principle—the denser solution with additive sunk to the bottom of the additive reservoir, diffused into the dosing chamber and exited an outlet near its bottom. The resulting current drew less dense water from the dosing chamber into the additive reservoir.

The invention provided some potentially realisable advantages as the whole system tended to be time based in its release (relying on rates of diffusion based on differing densities, rather than water flow and pressure) instead of being proportional to the rate of water usage. For animals in a field this can be important as on a hot day the animals drink much more than on a cool day. If dosing is proportion to water flow (for refilling the trough) the animals can be overdosed on a hot day, and under-dosed on a cool day. In practice it was found that the previous invention tended to release approximately the same amount of additive per day, regardless of water usage. This principle, as will be discussed later, has found also to be important for horticultural applications as plants may take up more water on a hot day than cool day. In each case, overdosing can have toxic effects on the plant or animal, while under-dosing may not achieve what the additive is used for. Hence there is an optimum window in many cases, with potentially serious consequences if one doses outside of that window.

While the previous invention was successful in the field for its intended application (animal water troughs), one limitation was that it tended to hold and dispense only one to two day's dosage. Scaling up the size of the reservoir was not always practical as this could also affect diffusion rates and hence additive dosing rates. In general, a larger reservoir and dosing chamber can introduce a larger potential head of pressure (relating to the height difference between the top and bottom apertures between the dosing chamber and additive reservoir) resulting in greater circulation rates in fluid entering the additive reservoir (from the dosing chamber) and returning to the dosing chamber (from the additive reservoir). This can be compensated for by physically controlling fluid flow in the unit, whether it be between the dosing chamber and additive reservoir, or inlets and outlets to/from the dosing chamber. However this requires smaller control jets and apertures to reduce water flow within the apparatus if one is to maintain the appropriate dosing rates. Unfortunately there are some practical issues associated with very small control jet apertures.

In the previous invention the control jets, which regulated water flow at key points, tended to be a solid element with a sufficiently small aperture. One practical issue that sometimes occurred was the occasional presence of air bubbles in the system blocking the jets with an airlock. As the system relied on the pressure from the convection of different density layers of fluid (rather than water inlet pressure from a pipe), the system could not always self clear these bubbles. Reducing the size of jet apertures further, to extend the time between refilling the additive reservoir, only increased the problem of air bubble airlocks. As these devices were used in the field under sometimes difficult conditions, the vibrations (of filling, or lifting the device from a trough) were as likely to introduce air bubbles and to dislodge them.

Accordingly there was a need to address the occasional issue of air-bubbles in existing systems, but to also provide a flow regulating assembly which was less susceptible to air bubble issues such as air locks. Addressing these problems would also be a significant step towards the design of additive dosing devices (particularly those which were substantially independent of fluid flow rate) which had an extended duration between refilling the additive reservoir.

Accordingly there is a need to provide an improved fluid flow control assembly which can operate at low fluid flows and be less susceptible to air bubble issues.

Accordingly, it is an object of the present invention to consider and go towards addressing the above problems.

It is a further object of the present invention to provide an improved fluid flow control assembly which can be used in additive dispensing apparatus.

At the very least it is an object of the present invention to provide the public with a useful alternative choice.

Aspects of the present invention will be described by way of example only and with reference to the ensuing description.

### GENERAL DESCRIPTION OF THE INVENTION

For clarity, it is beneficial to define several of the terms used within this specification:

The term “dosing chamber” refers to a chamber or reservoir into which fluid, to which an additive is to be added, is typically first introduced prior to being allowed to enter the additive reservoir.

The term “additive reservoir” refers to a chamber or reservoir into which an additive, for introduction to a fluid supply, is added.

The term “fluid flow control assembly” refers to apparatus regulating, controlling, and/or influencing the flow of fluid therethrough.

The term “baffle arrangement” refers to an element or assembly whose primary function is to cause, or contribute towards causing, a non-linear flow path of fluid within the fluid flow control assembly.

The term “baffle element” refers to an element used in the construction of a baffle arrangement. Baffle elements within a baffle arrangement may be identical to each other, or a baffle arrangement may be of baffle elements of different sizes and/or shapes.

According to one aspect of the present invention there is provided a fluid flow control assembly for use in an additive dispenser for dispensing additives into a fluid, said fluid flow control assembly comprising:
a body portion having length and defining an internal chamber;
a fluid inlet communicating with a first position in said internal chamber;
a fluid outlet communicating with a second position in said internal chamber, and in which said first and second positions are distanced apart;
there being present in said internal chamber between said first and second positions, a baffle arrangement through which fluid must pass when travelling between said first and second positions;
said baffle arrangement forming a series of alternating cavities and restrictions within said internal chamber through which fluid must pass when travelling between said first and second positions.

According to another aspect of the present invention there is provided a fluid flow control assembly, substantially as described above, in which the baffle arrangement comprises a sequence comprising a plurality of baffle elements capable of limited movement.

According to another aspect of the present invention there is provided a fluid flow control assembly, substantially as described above, in which the movement of the baffle elements are limited by the internal walls of said internal chamber.

According to another aspect of the present invention there is provided a fluid flow control assembly, substantially as described above, in which the movement of the baffle elements are limited by a baffle element restraining arrangement.

According to another aspect of the present invention there is provided a fluid flow control assembly, substantially as described above, in which the baffle element restraining arrangement comprises an element linking a plurality of said baffle elements.

According to another aspect of the present invention there is provided a fluid flow control assembly, substantially as described above, which biases said baffle elements towards each other.

According to another aspect of the present invention there is provided a fluid flow control assembly, substantially as described above, in which said moveable baffle elements are capable of movement in at least one of the following manners: towards and away from each other, in a direction having a directional component perpendicular to the direction to an adjacent baffle element, rotationally.

According to another aspect of the present invention there is provided a fluid flow control assembly, substantially as described above, in which fluid can pass between the outside of a baffle element and the internal wall of said internal chamber.

According to another aspect of the present invention there is provided a fluid flow control assembly, substantially as described above, in which a baffle element includes features on its outside face comprising channels through which fluid can flow.

According to another aspect of the present invention there is provided a fluid flow control assembly, substantially as described above, in which a baffle element, as it normally sits within said internal chamber, is of smaller dimensions than the internal dimensions of the portion of internal chamber in which it sits.

According to another aspect of the present invention there is provided a fluid flow control assembly, substantially as described above, in which a baffle element comprises a plate-like element.

According to another aspect of the present invention there is provided a fluid flow control assembly, substantially as described above, in which a plate-like element comprises, and/or is associated with, a separator.

According to another aspect of the present invention there is provided a fluid flow control assembly, substantially as described above, in which a said plate-like element comprises at least one aperture passing therethrough to permit fluid flow between said first and second positions.

According to another aspect of the present invention there is provided a fluid flow control assembly, substantially as described above, in which a baffle element comprises one or more of: a sphere, an oblate spheroid, and a polyhedron.

According to another aspect of the present invention there is provided a fluid flow control assembly, substantially as described above, in which a said baffle element includes one or more fluid passages or channels.

According to another aspect of the present invention there is provided a fluid flow control assembly, substantially as described above, in which the minimum size of a fluid restriction in the baffle arrangement, through which fluid must pass when flowing between said first and second positions, comprises a cross-section area of 0.6 mm².

According to another aspect of the present invention there is provided a fluid flow control assembly, substantially as described above, in which the average size of a fluid restriction in the baffle arrangement, through which fluid must pass when flowing between said first and second positions, comprises a cross-section area of between 0.75 mm² and 1200 mm².

According to another aspect of the present invention there is provided a fluid flow control assembly, substantially as described above, in which the average size of a fluid restriction in the baffle arrangement, through which fluid must pass when flowing between said first and second positions, does not exceed more than 7.5% in cross-sectional area to the maximum cross-sectional area of a cavity portion, said cross sectional areas measured perpendicularly to the flow of fluid between said first and second positions.

According to a further aspect of the present invention there is provided a dispenser for dispensing additives comprising:
an additive reservoir;
a dosing chamber;
an untreated fluid inlet for untreated fluid to enter the dosing chamber;
at least one chamber to reservoir passage allowing fluid from the dosing chamber to enter said additive reservoir;
at least one reservoir to chamber passage allowing fluid from the additive reservoir to enter said dosing chamber.
a dosing chamber outlet allowing treated fluid to exit the dosing chamber;
at least one fluid flow control assembly as claimed in any one of the preceding claims positioned in any one or more of the following positions:
   i) in the untreated fluid inlet to control the flow of untreated fluid into the dosing chamber;
   ii) in the dosing chamber outlet to control the flow of treated fluid from the dosing chamber;
   iii) in a chamber to reservoir passage to control the passage of fluid from the dosing chamber to additive reservoir;
   iv) in a reservoir to chamber passage to control the passage of fluid from the additive reservoir to dosing chamber.

According to another aspect of the present invention there is provided a dispenser for dispensing additives, substantially as described above, in which a said fluid flow control assembly is positioned in either or both of the dosing chamber's inlet and outlet, and wherein the chamber to reservoir, and reservoir to chamber, passages comprise common passages allowing fluid flow in either direction.

According to another aspect of the present invention there is provided a dispenser for dispensing additives, substantially as described above, in which the dosing chamber is positioned adjacent to, or within, the additive reservoir.

According to another aspect of the present invention there is provided a dispenser for dispensing additives, substantially as described above, in which the dosing chamber comprises a plurality of apertures in its walls adjacent the additive reservoir which act as common chamber to reservoir, and reservoir to chamber, passages.

According to another aspect of the present invention there is provided a dispenser for dispensing additives, substantially as described above, which includes a controllable fluid bypass to bypass a fluid flow control assembly.

According to another aspect of the present invention there is provided a dispenser for dispensing additives, substantially as described above, in which there is present a chamber to reservoir inlet whose opening into the dosing chamber is positioned vertically higher than the reservoir to chamber inlet when the dispenser is in a normal operational position.

According to another aspect of the present invention there is provided a dispenser for dispensing additives, substantially as described above, in which fluid flow control assemblies are positioned on either or both of said chamber to reservoir, and reservoir to chamber, passages to control fluid flow between the dosing chamber and additive reservoir, and wherein the arrangement is set up to promote the formation of a concentration gradient of additive in fluid within the dosing chamber.

According to another aspect of the present invention there is provided a dispenser for dispensing additives, substantially as described above, in which an untreated fluid inlet enters near the bottom of the dosing chamber, and a said dosing chamber outlet is positioned vertically higher than said inlet, when the dispenser is in a normal operational position.

According to another aspect of the present invention there is provided a dispenser for dispensing additives, substantially as described above, adapted to float in a reservoir containing fluid to be treated.

According to another aspect of the present invention there is provided a dispenser for dispensing additives, substantially as described above, adapted to be substantially submerged within a fluid reservoir containing fluid to be treated.

According to a further aspect of the present invention there is provided an in-line dispensing system in which fluid from a fluid line is diverted through a dispenser substantially as described above.

According to another aspect of the present invention there is provided an in-line dispensing system, substantially as described above, in conjunction with an in-line coupling for drawing fluid away from a fluid line and delivering it to the untreated fluid inlet, and in conjunction with an in-line coupling for introducing fluid from the chamber outlet to said fluid line.

According to another aspect of the present invention there is provided an in-line dispensing system, substantially as described above, which includes fluid restricting means between said in-line couplings for drawing fluid from, and introducing fluid to, said fluid line; said fluid restricting means restricting the flow of fluid through said fluid line.

According to another aspect of the present invention there is provided a method of dosing fluid with an additive or additives comprising the use of a dispenser substantially as described above.

According to another aspect of the present invention there is provided a method of dosing fluid with an additive or additives, substantially as described above, in which the fluid is animal drinking water or fluid.

According to another aspect of the present invention there is provided a method of dosing fluid with an additive or additives, substantially as described above, in which an additive comprises any one or more of: a soluble zinc compound, an antibiotic, a fungicide, a bactericide, a nutritional supplement, soluble mineral compounds, soluble vitamins, and dehydration replacement salts.

According to another aspect of the present invention there is provided a method of dosing fluid with an additive or additives, substantially as described above, in which the fluid is for watering plants.

According to another aspect of the present invention there is provided a method of dosing fluid with an additive or additives, substantially as described above, in which an additive comprises any one or more of the following: a source of plant available nitrogen, a source of plant available phosphorus, a source of plant available sulphur, a source of plant available potassium, a source of plant available trace minerals, a pH altering substance, a pH buffering substance, a fungicide, a bactericide, a plant active hormone, beneficial plant micro-organisms.

It is envisaged that the present invention may have a wide range of potential applications, in particular the dosing of animal water supplies. However it may also find application in horticultural applications, particularly (but not necessarily) under controlled growing conditions such as in green-houses and hydroponic installations. Aquarium dosing, swimming pool dosing, and many other applications may be considered. However, for simplicity of description, the present description within the specification will focus primarily on the principles and applications involving the dosing of animal water supplies, unless otherwise stated. Given that this is one of the most demanding applications of the present invention, it is assumed that the skilled reader can, upon reading this specification, apply these principles and information to other applications without additional inventive input.

It has been mentioned that very small apertures can suffer from issues with air locks from air bubbles in a system. They are also equally vulnerable to sediment and foreign particles which are present in many outdoor systems. Hence, it is likely that the present invention will be used in environments where blockages of small apertures are an issue.

Preliminary work by the inventors has yielded several alternatives to small apertures, and which are less susceptible to the presence of air bubbles or foreign material. The common principle of these alternatives comprises allowing the fluid flow through a path comprising an alternating series of cavities and restrictions. This introduces some flow turbulence which helps dislodge and lessen the effect of bubbles or foreign particles, though some embodiments introduce additional principles to further reduce susceptible to such bubbles and particles—see discussion later.

The following description of principle is based on the inventor's current understanding of the invention. In a low pressure system it is considered that the flow of a fluid through a hole or length of tube is greatly influenced by the change from a low rate of flow to a higher velocity flow as it enters a restriction. Once the fluid enters the higher velocity region it generally establishes a character of laminar streamlined flow. This flow is typically non-turbulent, and the result is very little head-loss or pressure drop.

If subsequent to such a restriction the fluid enters a cavity or region of larger diameter, the laminar flow is interrupted and turbulent flow is introduced. If the flow path is again restricted, a further change in the flow pattern is introduced, with consequential losses in pressure and overall flow rates. By repeating an alternating sequence of restrictions and cavities, an increasing overall restriction to flow (at a given low pressure) can be achieved. In such cases, because the effect appears to be additive (in relation to the number and nature of restrictions/cavities) one avoids the need to have very small apertures to restrict fluid flow. Hence we have the opportunity to create flow restricting devices for operating at low flows and pressures, without the need for very small apertures which are susceptible to blocking or interference.

Accordingly, a fluid flow control assembly (for regulating the flow of fluid at low pressures) according to the present invention typically comprises a baffle arrangement in the path of the fluid to be regulated. This can be simply achieved by placing the baffle arrangement within a chamber, with an inlet at a first point and an outlet at a second point. For fluid to travel from the first point to the second point it must pass the baffle arrangement.

The baffle arrangement may take several forms, and in the case of the preferred embodiments (to be discussed later) also utilise the internal walls of the chamber (which may be the internal chamber of the fluid flow control assembly's body) to restrict and direct the flow of fluid between the first and second points.

A range of specific arrangements exist for constructing the baffle arrangement. While the baffle arrangement may comprise a single element (forming alternating cavities and restrictions) it is generally cheaper and simpler to construct the baffle arrangement of separate baffle elements. We shall restrict the description to baffle arrangements of multiple elements for simplicity, noting that a unitary baffle arrangement will typically resemble an assembly of the separate baffle elements.

In one preferred arrangement the baffle arrangement comprises baffle elements which each comprise a restriction and cavity. Typically these are elements which have a removed portion or void in them to form a cavity portion of the baffle arrangement. They will typically also include a restriction of some type—which may be a channel or the like to restrict the passage of fluid between its outside and the internal wall of the internal chamber, though may rely on an aperture therethrough (for instance).

One example of this arrangement is the use of disc like elements which assemble together. Each disc-like element has some thickness and included a cavity which opens to one of its major faces. In principle it may resemble a washer (for nuts and bolts) placed on top of a coin, and in fact alternating discs and annular rings may be substituted. An aperture may be provided through the disc to allow flow therethrough and to the next chamber, though channels and other removed portions may be provided about the circumferential edges (typically the discs/elements are circular, though other configurations can be substituted). Such apertures/channels provide the restrictions in the baffle arrangement sequence, while the cavity portions represent the cavities. As can be appreciated, there are many ways of implementing this type of arrangement.

As a note, apertures and channels on the discs may be staggered or placed differently to ensure that fluid has a tortuous and non-linear path through the baffle arrangement. The discs may be of smaller diameter than the internal diameter of the internal chamber, thus eliminating the need for channels formed into the circumferential edges of the disc in some embodiments.

The second preferred arrangement relies on baffle elements which rely primarily on the flow of fluid between their outside and the internal wall of the internal chamber as a restriction, and voids between facing surfaces of adjacent elements to create the cavities.

Perhaps the simplest example of such baffle elements is spherical or oblate spherical elements of slightly smaller diameter than the walls of the internal chamber. These ‘beads’ are repeated alternately though may include a spacer element between them to increase the cavity size. In practice, however, it has been found that a repeating sequence of identically sized spherical beads is adequate, and these are used in a preferred embodiment of the present invention.

The third arrangement relies generally on an alternating sequence of restrictors and spacers to create the alternating sequence of restrictions and cavities. This may utilise elements acting as a restriction, such as discs with apertures in them, elements which are marginally smaller in diameter than that of the internal chamber, and various other designs which restrict the flow of fluid. Betwixt these are spacer elements which create a void or cavity by virtue of keeping the adjacent faces of the restricting elements apart.

It is possible that separators and restrictors may be merged into a single baffle element, or present as separate elements, according to user choice.

While the baffle arrangement may comprise a unitary single baffle element, additional benefit may be obtained by utilising multiple baffle elements. In such a case such additional benefit may be obtained if the baffle elements have a degree of movement. Depending on the particular embodiment, this movement may be substantially longitudinal (i.e. generally in the direction of the path between said first and second inlet/outlet points (of the fluid flow control assembly) within the internal chamber), rotational, and/or having a component substantially perpendicular to said longitudinal direction.

The potentially realisable advantage of such movement is that a permitted degree of movement can help bubbles and foreign particles to negotiate through the baffle arrangement and exit through the outlet. This movement may be induced by localised pressure build up or flow reduction due to an obstructing particle, by the normal flow of fluid, and/or physical movement transmitted from the environment that the fluid flow control assembly is in. This movement therefore helps the fluid flow control assembly to become self cleaning for most minor obstructions, though ideally a separate filter is used to remove large particles.

Ideally the movement of moveable baffle elements is restrained or restricted. The internal chamber itself may be sufficient to contain the baffle elements. Features on the internal wall of the internal chamber may help individually or collectively locate baffle elements. In a preferred embodiment a restraining element, comprising a wire, links the baffle elements. This string of baffle elements may move freely within the internal chamber, though again movement may be limited by the size and dimensions of the internal chamber. Such a wire or restraining element may be flexible, and may be elastic in nature to bias the baffle elements towards each other. Other arrangements (e.g. compressible elastic members between each end of the baffle arrangement and end walls of the internal chamber) may also be used to bias the baffle elements towards each other.

The size (in cross-sectional area, which represents the area generally perpendicular to the longitudinal (see above)) of a restriction varies in different embodiments. As mentioned previously, restrictions need not be as small in cross-sectional area as apertures in traditional fluid control jets, but may be. As apertures need not be circular, but may comprise an annular gap between a baffle element and the internal wall of the internal chamber, the issues of blockages associated with circular apertures may be alleviated. This will be more so if the elements have a degree of movement within the internal chamber—see preceding discussion on potentially self-clearing nature of embodiments with moveable baffle elements.

While the cross-sectional area (measured perpendicular to the perpendicular) may be as small as 0.6 mm², and in specialised cases (e.g. well filtered systems, fluids other than water, etc.) may be even smaller. This may find applications for intravenous drip flow regulation, or other medical and veterinary applications.

In practice however, most restrictions will be in the range of 0.75 mm² to 1200 mm² for most common horticultural and agricultural applications. It is envisaged that higher restriction cross-sectional areas may be used in specialised applications.

While the size of the actual fluid flow control assembly will affect exact proportions, it is envisaged that most restrictions will be less than 7.5% of the maximum cross-sectional area of the passage (within the internal chamber) within their vicinity, while a cavity may open up to 75% or more of said maximum cross-sectional area. However, the flow characteristics of each embodiment will need to optimised, and such figures are starting guidelines rather than precise limits governing all embodiments. It should also be remember that the length of the path between said first and second inlet/outlet points, as well as the number of alternating sequences of restrictions and cavities, will have a bearing on the flow characteristics of the fluid flow control assembly. Hence a long path fluid flow control assembly with 20 alternating sequences will be more flow restrictive than a shorter path fluid flow control assembly with four alternating sequences. In the former case, larger restriction cross-sectional areas may be employed related to the short path example. The former long path example may be preferred where foreign obstructions and bubbles may be likely, though most preferred embodiments have from 8 to 12 (inclusive) repeating restriction/cavity sequences.

A fluid flow control assembly as described above may be used in a dispenser for dispensing additives. Some specific examples will be given later in relation to the drawings. However the following general comments are made. For illustrative purposes these comments are made in relation to the same general type of dispenser of the inventor as discussed in the Background Art section of this specification.

The total rate of release of additive into a system by a dispenser of the present invention is determined largely by the permitted flow rate of fresh fluid into the dispenser and from the dispenser. As previously mentioned the flow is largely determined by the fluid flow control assemblies, and openings communicating fluid between the dosing chamber and additive reservoir. Hence, a fluid flow control assembly of the present invention may be used in a dispenser of this general type in one or more of the following manners:
i) in the untreated fluid inlet to control the flow of untreated fluid into the dosing chamber;
ii) in the dosing chamber outlet to control the flow of treated fluid from the dosing chamber;
iii) in a chamber to reservoir passage to control the passage of fluid from the dosing chamber to additive reservoir;
iv) in a reservoir to chamber passage to control the passage of fluid from the additive reservoir to dosing chamber.

In the prior art dispensers (in which the present fluid flow control assembly may be used) the fluid flow control jet was typically positioned to control treated fluid from the dosing chamber outlet and/or the dosing chamber inlet. These still represent ideal positions for positioning a fluid flow control assembly, though control of the fluid between the dosing chamber and additive reservoir may also be considered. Again, this provides the user with a high degree of choice for constructing a range of embodiments suitable for different applications and requirements.

Such a dispenser may be constructed to float or be immersed (partially or fully) in a larger reservoir of fluid to be treated. Similarly a dispenser may be constructed to treat an inline fluid source—e.g. to introduce additive into a pipe carrying the fluid to be treated. For such ‘in-line’ dosing the dispenser is typically plumber in parallel with the pipeline, with a small amount of fluid being diverted from the pipeline for entry into the dispenser, and with an additional coupling downstream to allow treated fluid to return. Ideally flow control valves are provided to fine tune the flow and pressure of fluid delivered to the dispensing apparatus. These valves may be less critical in low pressure systems, but recommended in high pressure systems to prevent excess fluid being forced through the fluid flow control assemblies of the dispenser. Pressure reducing valves may be considered in some situations.

A flow control valve in the pipeline, between the connections to the dispenser, may be considered to ensure that a small head of pressure is presented to the dispenser in order for the system to work effectively, and to allow some additional user control over dose rates.

As can be appreciated, additives may take many forms. They may comprise solids, liquids, slow release formulation, time release substances and capsules, gels, high viscosity fluids, etc. The content of these additives may comprise, for instance: a soluble zinc compound, an antibiotic, a fungicide, a bactericide, a nutritional supplement, soluble mineral compounds, soluble vitamins, and dehydration replacement salts, a source of plant available nitrogen, a source of plant available phosphorus, a source of plant available sulphur, a source of plant available potassium, a source of plant available trace minerals, a pH altering substance, a pH buffering substance, a plant active hormone, beneficial plant micro-organisms, pool sterilisation chemicals, and so on.

Possible applications include agricultural uses, horticultural uses, medical and veterinary applications, sterilisation of water supplies, slow release of additives into tanks and vats (e.g. fermentation processes, etc.), as well as the slow release of additives into lakes, oceans and waterways (e.g. to control pests, microorganism infestations, fungal overgrowth, industrial spills, etc.). In such cases, inexpensive, disposable biodegradable dispensers may be utilised for specialised one-off applications.

### DESCRIPTION OF DRAWINGS

FIG. 1 is a side diagrammatic view of one embodiment of the present invention,

FIG. 2 is a side diagrammatic view of another embodiment of the present invention,

FIG. 3 is a diagrammatic view of an embodiment of an inline dispenser, and

FIG. 4 is a diagrammatic view of an embodiment of a floating dispenser.

### DESCRIPTION OF PREFERRED EMBODIMENT

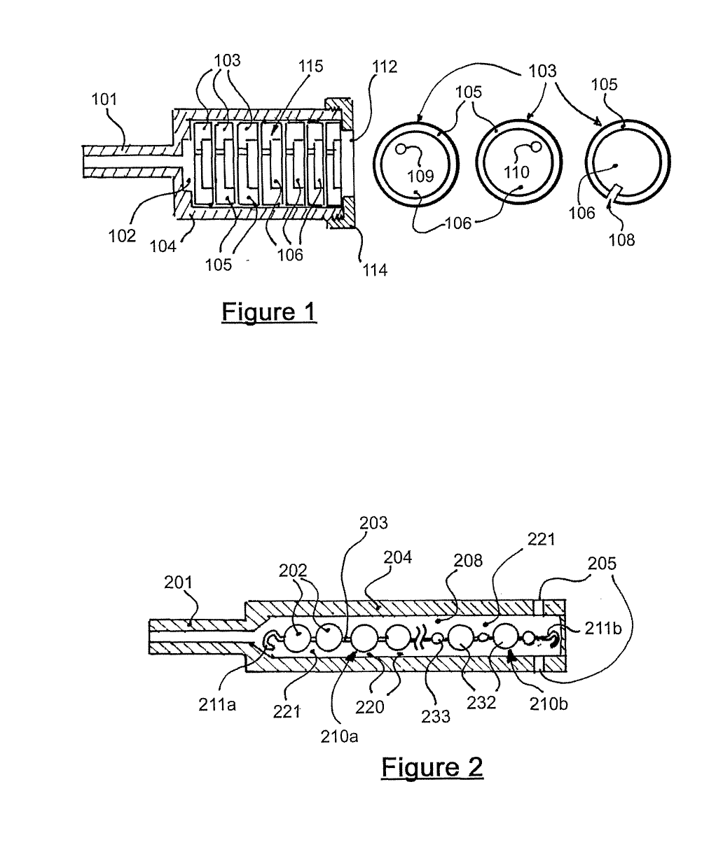

FIG. 1 illustrates one embodiment of a fluid flow control assembly according to the present invention. The fluid flow control assembly comprises a body of two pieces (104, 114) which may be of plastic or metal. The body (104, 114) defines an internal chamber (102). At one end is an inlet aperture (112) and at the distal end an outlet (101) through the device is non-directional and may be used either way around (e.g. aperture (101) may be the inlet)).

Within the internal chamber (102) is a baffle arrangement (generally indicated by arrow 115) comprising a plurality of baffle elements (103). Each baffle element (103) comprises a plate-like element having a raised annular ridge (105) defining a recessed central cavity region (106). Apertures (109) and (110) are placed in alternate positions to make the flow of fluid through the baffle elements (103) more tortuous. Additionally or instead of apertures (109, 110), channels (108) in the outer edge of each element may be provided to let fluid flow past each baffle element (103).

FIG. 2 illustrates a preferred embodiment of a fluid flow control assembly comprising a body (204) defining an internal chamber (208). Within this chamber (208) two differing embodiments of a baffle arrangement (210a, 210b) are illustrated. The first baffle arrangement (210a) comprises a sequence of baffle elements (202) each comprising a spherical bead of slightly smaller diameter than that of the internal chamber. Each bead is linked by a restraining element (203) comprising a wire. The wire is terminated at each end (211a, 211b) to retain the beads (202). The terminations are further apart than the sum of the diameters of the beads (202) thereby allowing their individual movement along the direction of the wire (203)—i.e. the longitudinal direction—while the smaller diameter of the beads (202) relative to the internal chamber also means they can move perpendicularly to the longitudinal as well. This relative freedom of movement, as well as being able to rotate about the wire (203) helps provide sufficient movement for the baffle elements (202) to be self-clearing of minor foreign particles and air bubbles, or to adjust in position to still allow fluid flow through the fluid flow control assembly.

The second baffle arrangement (210b) is similar to the first (210a) except separating elements (233) are placed on the wire (203) between each larger size baffle element (232). For comparison, the baffle elements (232) may be the same as elements (202) in the first baffle arrangement (210a). The general principles of operation of this second baffle arrangement (210b) are generally the same as discussed for first baffle arrangement (210a).

Please note also that FIG. 2 is not to scale and is for illustrative purposes. In practice the diameter of the larger baffle elements (202, 232) will be relatively close to that of the internal diameter of internal chamber (208)—see below for some typical dimensions of a preferred embodiment.

As can be seen the restrictions (220) of the baffle arrangement (210) occur where the diameter of the beads (202, 232) is greatest, while the cavity represents the volume (221) of reducing diameter defined between adjacent beads.

The internal diameter of the internal chamber (208) for an animal trough application is typically from 8 through 15 mm in diameter. The diameter of the beads is typically 0.75 through 2 mm less than the diameter of the internal chamber. Typically 8 through 12 beads (202, 232) are used, with an average individual free-play (longitudinally) of 0.5 to 3 times the difference in diameter between the beads (20, 2322) and internal chamber (208).

At one end is an inlet (201) and near the distal end a dual outlet (205). The fluid flow control assembly is, again, non-directional and may be connected either way around.

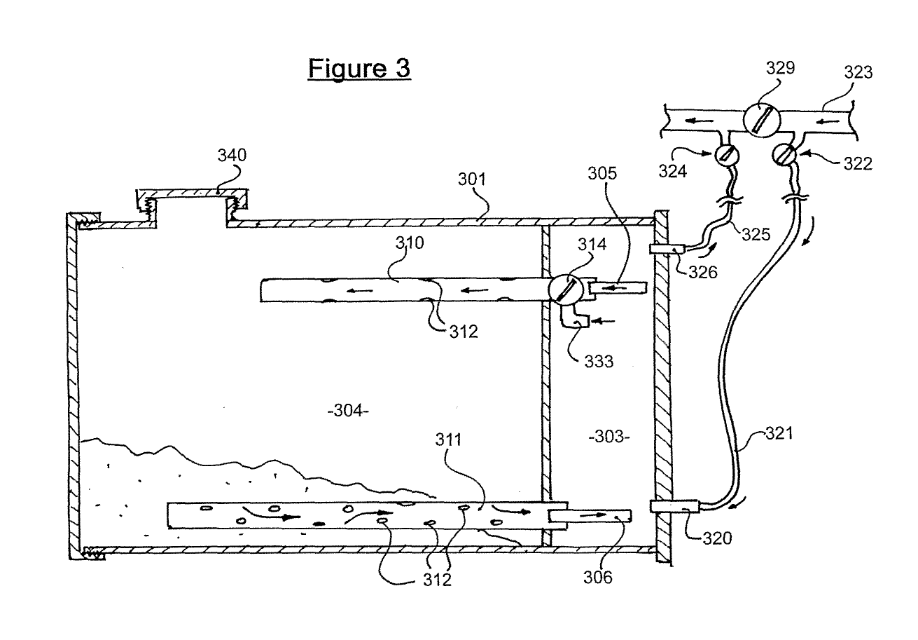

FIG. 3 illustrates an embodiment of a dispenser for use in an inline dosing arrangement. The dispenser comprises a body (301) of 300 mm diameter pipe sectioned off (302) to provide a dosing chamber (303) and additive reservoir (304). The approximate size of the dosing chamber is 5 litres, while the additive chamber is 30-50 litres.

A chamber to reservoir pipe (310) allows fluid to travel from the dosing chamber (303) to additive reservoir (304). At the dosing chamber end of this pipe is a fluid flow control assembly (305) regulating the flow of fluid through this pipe (310). Return flow from the reservoir (304) to dosing chamber (303) is via reservoir to chamber pipe (311) which also has a fluid flow control assembly (306) at the dosing chamber end to regulate fluid flow further. Apertures (312) in the reservoir to chamber pipe (311) allow a more even flow of treated fluid back into the dosing chamber (303). A filter gauze may (not shown) map be placed over the apertures (312) to help prevent foreign material and solid additive from reaching the fluid flow control assembly (306). Similar apertures (to 312) may also be provided of the reservoir side of chamber to reservoir pipe (310).

A filler cap (340) allows additive to be added to the additive reservoir (304). Ideally the additive is of a type which allows fluid to permeate through the settled mass, so as not to clog pipes (310) and (311) though other pipe designs may be used if clogging is a potential issue. Preferred additive types to prevent clogging of the illustrated embodiment are granular, crystalline, capsular, agglomerates, tablets, gelled particles, etc. (as opposed to free fine and microfine powders which could be problematic in the illustrated embodiment's design)

Where higher dosing rates are required, a bypass valve (314) (controllable from outside the dosing chamber) may be provided to bypass the fluid flow control assembly (305) and allow chamber to reservoir pipe (310) to draw fluid directly (333) from the dosing chamber (303). A fluid inlet (320) is connected by hose (321) to a valve coupling (322) to pipeline (323). Downstream a further valve coupling (324) returns additive treated fluid to the pipeline (323), and is connected by hose (325) to an outlet (326) from the dosing chamber (303). A restrictor (329) may be placed in the pipeline (323) between couplings (323) and (324), and may take the form of a flow control valve.

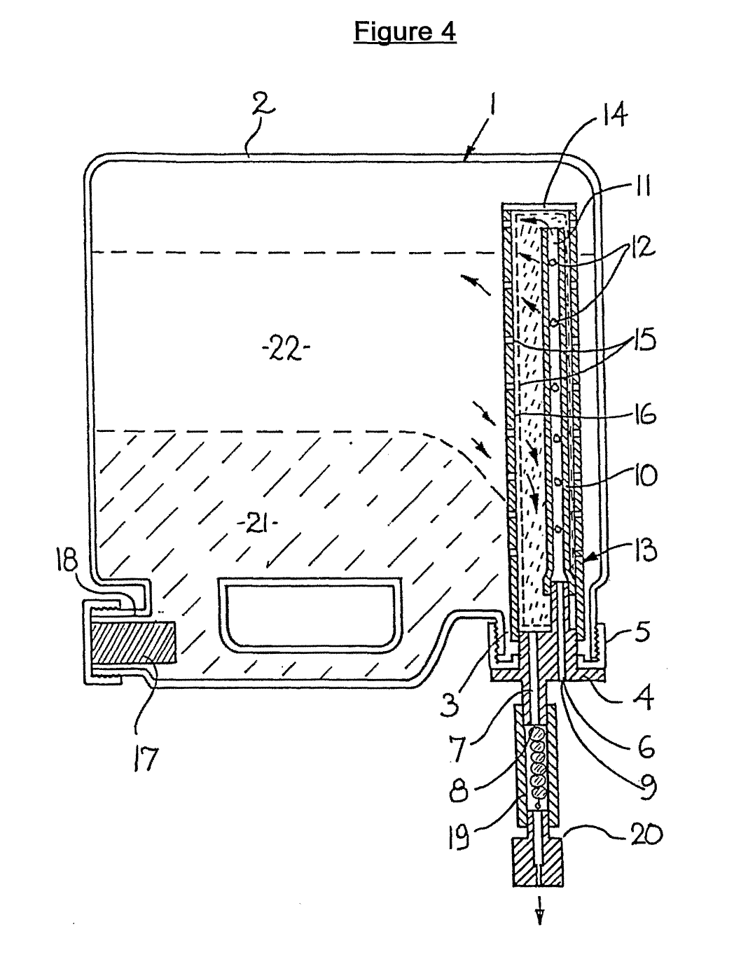

FIG. 4 illustrates a floating dispenser which may be used in a vat or animal trough. In this embodiment the dosing chamber (13) is formed by a closed pipe section (14). Fluid from the trough enters upwardly through size restricted conduit (6) which leads into a distribution pipe (10) with a plurality of apertures (11, 12) therein to introduce the fluid evenly into the chamber (13). Apertures (15) in the wall (16) of the dosing chamber (13) allow fluid to pass into the reservoir (2) to mingle with additive (21). A concentration gradient with a heavier lower layer (22) forms and this heavier fluid slowly flows back into the dosing chamber (13)—the flow arrows illustrate the typical flow of fluid in the system.

The heavier treated fluid collects at the bottom of the dosing chamber (13) and flows through conduit (7) whereupon it encounters fluid flow control assembly (19) before exiting via outlet (20). The fluid flow control assembly regulates the flow of heavier treated fluid more effectively (and less problematically) than a fine aperture. It is noted that the a fluid flow control assembly can also, or instead, be connected to the inlet (9) of conduit (6) for further flow regulation of fluid into and out of the dispenser. The outlet (20) may also have a filter gauze, rather than a restricted outlet aperture, to prevent backwash of contaminants into the system during refilling and use, or may be omitted altogether.

Aspects of the present invention have been described by way of example only and it should be appreciated that modifications and additions may be made thereto without departing from the spirit or scope of the present invention as described herein.

It should also be understood that the term “comprise” where used herein is not to be considered to be used in a limiting sense. Accordingly, ‘comprise’ does not represent nor define an exclusive set of items, but includes the possibility of other components and items being added to the list.

This specification is also based on the understanding of the inventor regarding the prior art. The prior art description should not be regarded as being authoritative disclosure on the true state of the prior art but rather as referencing considerations brought to the mind and attention of the inventor when developing this invention.

1-36. (canceled)

37. A fluid flow control assembly for use in an additive dispenser for dispensing additives into a fluid, said fluid flow control assembly comprising:
a body portion having length and defining an internal chamber;
a fluid inlet communicating with a first position in said internal chamber;
a fluid outlet communicating with a second position in said internal chamber, and in which said first and second positions are distanced apart;
there being present in said internal chamber between said first and second positions, a baffle arrangement through which fluid must pass when travelling between said first and second positions;
said baffle arrangement forming a series of alternating cavities and restrictions within said internal chamber through which fluid must pass when travelling between said first and second positions—and in which the baffle arrangement comprises a sequence comprising a plurality of baffle elements capable of limited movement.

38. A fluid flow control assembly as claimed in claim 37 in which the movement of the baffle elements are limited by either or both:
(i) the internal walls of said internal chamber, and
(ii) a baffle element restraining arrangement comprising an element linking a plurality of said baffle elements.

39. A fluid flow control assembly as claimed in claim 37 which biases said baffle elements towards each other.

40. A fluid flow control assembly as claimed in claim 37 in which said moveable baffle elements are capable of movement in at least one of the following manners: towards and away from each other, in a direction having a directional component perpendicular to the direction to an adjacent baffle element, rotationally.

41. A fluid flow control assembly as claimed in claim 37 in which fluid can pass between the outside of a baffle element and the internal wall of said internal chamber and in which a baffle element includes features on its outside face comprising channels through which fluid can flow.

42. A fluid flow control assembly as claimed in claim 37 in which a baffle element comprises a plate-like element and in which a plate-like element comprises, and/or is associated with, a separator.

43. A fluid flow control assembly as claimed in claim 37 in which a baffle element comprises one or more of: a sphere, an oblate spheroid, and a polyhedron.

44. A fluid flow control assembly as claimed in claim 37 in which a said baffle element includes one or more fluid passages or channels.

45. A fluid flow control assembly as claimed in claim 37 in which the minimum size of a fluid restriction in the baffle arrangement, through which fluid must pass when flowing between said first and second positions, comprises a cross-section area of 0.6 mm².

46. A fluid flow control assembly as claimed in claim 37 in which the average size of a fluid restriction in the baffle arrangement, through which fluid must pass when flowing between said first and second positions, does not exceed more than 7.5% in cross-sectional area to the maximum cross-sectional area of a cavity portion, said cross sectional areas measured perpendicularly to the flow of fluid between said first and second positions.

47. A dispenser for dispensing additives comprising:
an additive reservoir;
a dosing chamber;
an untreated fluid inlet for untreated fluid to enter the dosing chamber;
at least one chamber to reservoir passage allowing fluid from the dosing chamber to enter said additive reservoir;
at least one reservoir to chamber passage allowing fluid from the additive reservoir to enter said dosing chamber.
a dosing chamber outlet allowing treated fluid to exit the dosing chamber;
at least one fluid flow control assembly as claimed in claim 37 positioned in any one or more of the following positions:
i) in the untreated fluid inlet to control the flow of untreated fluid into the dosing chamber;
ii) in the dosing chamber outlet to control the flow of treated fluid from the dosing chamber;
iii) in a chamber to reservoir passage to control the passage of fluid from the dosing chamber to additive reservoir;
iv) in a reservoir to chamber passage to control the passage of fluid from the additive reservoir to dosing chamber.

48. A dispenser for dispensing additives, as claimed in claim 47, in which a fluid flow control assembly is positioned in either or both of the dosing chamber's inlet and outlet, and wherein the chamber to reservoir, and reservoir to chamber, passages comprise common passages allowing fluid flow in either direction.

49. A dispenser for dispensing additives, as claimed in claim 47, in which the dosing chamber is positioned adjacent to, or within, the additive reservoir and in which the dosing chamber comprises a plurality of apertures in its walls adjacent the additive reservoir which act as common chamber to reservoir, and reservoir to chamber, passages.

50. A dispenser for dispensing additives as claimed in claim 47 which includes a controllable fluid bypass to bypass a fluid flow control assembly.

51. A dispenser for dispensing additives as claimed in claim 50 in which there is present a chamber to reservoir inlet whose opening into the dosing chamber is positioned vertically higher than the reservoir to chamber inlet when the dispenser is in a normal operational position.

52. A dispenser for dispensing additives as claimed in claim 51 in which fluid flow control assemblies are positioned on either or both of said chamber to reservoir, and reservoir to chamber, passages to control fluid flow between the dosing chamber and additive reservoir, and wherein the arrangement is set up to promote the formation of a concentration gradient of additive in fluid within the dosing chamber.

53. A dispenser for dispensing additives as claimed in claim 47 adapted to float in a reservoir containing fluid to be treated.

54. A dispenser for dispensing additives as claimed in claim 37 when used in an in-line dispensing system, and in which fluid from a fluid line is diverted from a fluid line through a dispenser for dispensing additives comprising:
an additive reservoir;
a dosing chamber;
an untreated fluid inlet for untreated fluid to enter the dosing chamber;
at least one chamber to reservoir passage allowing fluid from the dosing chamber to enter said additive reservoir;
at least one reservoir to chamber passage allowing fluid from the additive reservoir to enter said dosing chamber.
a dosing chamber outlet allowing treated fluid to exit the dosing chamber;
at least one fluid flow control assembly as claimed in claim 37 positioned in any one or more of the following positions:
i) in the untreated fluid inlet to control the flow of untreated fluid into the dosing chamber;
ii) in the dosing chamber outlet to control the flow of treated fluid from the dosing chamber;
iii) in a chamber to reservoir passage to control the passage of fluid from the dosing chamber to additive reservoir;
iv) in a reservoir to chamber passage to control the passage of fluid from the additive reservoir to dosing chamber.

55. A dispenser for dispensing additives as claimed in claim 37 when used in an in-line dispensing system as claimed in claim 37 when used in an in-line dispensing system, and in which fluid from a fluid line is diverted from a fluid line through a dispenser for dispensing additives comprising:
an additive reservoir;
a dosing chamber;
an untreated fluid inlet for untreated fluid to enter the dosing chamber;
at least one chamber to reservoir passage allowing fluid from the dosing chamber to enter said additive reservoir;
at least one reservoir to chamber passage allowing fluid from the additive reservoir to enter said dosing chamber.
a dosing chamber outlet allowing treated fluid to exit the dosing chamber;
at least one fluid flow control assembly as claimed in claim 37 positioned in any one or more of the following positions:
i) in the untreated fluid inlet to control the flow of untreated fluid into the dosing chamber;
ii) in the dosing chamber outlet to control the flow of treated fluid from the dosing chamber;
iii) in a chamber to reservoir passage to control the passage of fluid from the dosing chamber to additive reservoir;
iv) in a reservoir to chamber passage to control the passage of fluid from the additive reservoir to dosing chamber;
which includes fluid restricting means between said in-line couplings for drawing fluid from, and introducing fluid to, said fluid line; said fluid restricting means restricting the flow of fluid through said fluid line.
